(19) United States
(12) Patent Application Publication
(10) Pub. No.: US 2026/0188306 A1
(43) Pub. Date: Jul. 2, 2026

(54) EFFICIENT CONFLICT RESOLUTION FOR SELECTIVE ATTENTION

(71) Applicant: Attention Labs Incorporated, Newark, DE (US)

(72) Inventors: Bonny Banerjee, Collierville, TN (US); Daniyal Anjum, Milton (CA); Omar Abbasi, Guelph (CA); David J. Kim, Toronto (CA)

(21) Appl. No.: 19/415,831

(22) Filed: Dec. 11, 2025

Related U.S. Application Data
(63) Continuation-in-part of application No. 19/386,258, filed on Nov. 12, 2025.
Application No. 19/386,258 is a continuation of application No. 19/386,190, filed on Nov. 11, 2025.
Application No. 19/386,190 is a continuation of application No. 19/357,513, filed on Oct. 14, 2025.
Application No. 19/357,513 is a continuation-in-part of application No. 19/298,180, filed on Aug. 13, 2025.
Application No. 19/298,180 is a continuation of application No. 19/296,932, filed on Aug. 12, 2025.
Application No. 19/296,932 is a continuation of application No. 19/241,399, filed on Jun. 18, 2025.
Application No. 19/241,399 is a continuation of application No. 19/236,996, filed on Jun. 13, 2025.
Application No. 19/236,996 is a continuation of application No. 19/221,496, filed on May 28, 2025.
Application No. 19/221,496 is a continuation of application No. PCT/US25/29916, filed on May 18, 2025.
Application No. PCT/US25/29916 is a continuation-in-part of application No. 19/093,220, filed on Mar. 27, 2025.
Application No. 19/093,220 is a continuation of application No. 19/069,128, filed on Mar. 3, 2025.
(60) Provisional application No. 63/739,560, filed on Dec. 28, 2024.
(60) Provisional application No. 63/741,998, filed on Jan. 6, 2025.

(51) Int. Cl. G10L 15/02; G10L 15/16

(52) U.S. Cl. CPC G10L 15/02; G10L 15/16

(57) ABSTRACT

A closed-loop selective attention system for resolving conflicts in multi-source or multi-speaker environments, including a plurality of internal attention models, each outputting a probability distribution over candidate sources and an associated confidence score, a fuser detecting conflicts when two or more of said attention models output high-confidence predictions that disagree, a selective sampling policy querying one or more external agents, wherein each external agent possesses a knowledge base, a reliability model, and a communication protocol, a trust and reliability module assigning and updating dynamic trust scores for internal and external agents based on past performance, an efficiency optimizer minimizing communication overhead and decision delay by balancing token usage cost and latency cost, and a dynamical system formulator ensuring convergence of the conflict resolution process under bounded trust, decaying step size, and limited sampling.

### REFERENCE TO RELATED APPLICATIONS

This application claims the benefit of (i) U.S. Provisional Application No. 63/739,560 entitled ATTENTION MODELING IN MULTI-SPEAKER ENVIRONMENTS and filed on Dec. 28, 2024 by inventors David J. Kim, Omar Abbasi and Daniyal Anjum, of (ii) U.S. Provisional Application No. 63/741,998 entitled ATTENTION MODELING IN MULTI-SPEAKER ENVIRONMENTS and filed on Jan. 6, 2025 by inventors David J. Kim, Omar Abbasi and Daniyal Anjum, of (iii) U.S. patent application Ser. No. 19/069,028 entitled ATTENTION MODELING IN MULTI-SPEAKER ENVIRONMENTS and filed on Mar. 3, 2025 by inventors David J. Kim, Omar Abbasi and Daniyal Anjum, of (iv) U.S. patent application Ser. No. 19/093,220 entitled SELECTIVE AUDITORY ATTENTION IN MULTI-PARTICIPANT ENVIRONMENTS and filed on Mar. 27, 2025 by inventors David J. Kim, Omar Abbasi and Daniyal Anjum, of (v) U.S. patent application Ser. No. 19/221,496 entitled SELECTIVE AUDITORY ATTENTION IN MULTI-PARTICIPANT ENVIRONMENTS and filed on May 28, 2025 by inventors David J. Kim, Omar Abbasi, Daniyal Anjum and Bonny Banerjee, of (vi) U.S. patent application Ser. No. 19/236,996 entitled DYNAMIC CONVERSATION GRAPH GENERATION and filed on Jun. 13, 2025 by inventors David J. Kim, Omar Abbasi, Daniyal Anjum and Bonny Banerjee, of (vii) U.S. patent application Ser. No. 19/241,399 entitled DISTRIBUTED PROCESSING ARCHITECTURE FOR ATTENTION MODELING and filed on Jun. 18, 2025 by inventors David J. Kim, Omar Abbasi, Daniyal Anjum and Bonny Banerjee, of (viii) U.S. patent application Ser. No. 19/296,932 entitled MULTI-PARTICIPANT CONVERSATION STATE DETECTION and filed on Aug. 12, 2025 by inventors David J. Kim, Omar Abbasi, Daniyal Anjum and Bonny Banerjee, of (ix) U.S. patent application Ser. No. 19/298,180 entitled MULTI-PARTICIPANT VOICE ACTIVITY DETECTION and filed on Aug. 13, 2025 by inventors David J. Kim, Omar Abbasi, Daniyal Anjum and Bonny Banerjee, of (x) U.S. patent application Ser. No. 19/357,513 entitled CONTEXT-AWARE DYNAMIC ATTENTION WITH CONVERSATIONAL GRAPHS AND UTILITY SCHEDULING and filed on Oct. 14, 2025 by inventors Bonny Banerjee, David J. Kim, Omar Abbasi and Daniyal Anjum, of (xi) U.S. patent application Ser. No. 19/360,913 entitled SPATIAL AUDIO PROCESSING WITH MOTION-COMPENSATED BEAMFORMING and filed on Oct. 16, 2025 by inventors David J. Kim, Omar Abbasi, Daniyal Anjum and Bonny Banerjee, of (xii) U.S. patent application Ser. No. 19/369,612 entitled SYSTEMS AND METHODS FOR DYNAMIC REAL-TIME GROUPING OF MULTILINGUAL MULTI-SPEAKER TEXT STREAMS BY CONVERSATION TOPICS and filed on Oct. 27, 2025 by inventors Sina Gholamian, Bonny Banerjee, Daniyal Anjum, Omar Abbasi and David J. Kim, of (xiii) U.S. patent application Ser. No. 19/386,190 entitled UNIFIED SYSTEM FOR SELECTIVE ATTENTION IN MULTI-SOURCE ENVIRONMENTS and filed on Nov. 11, 2025 by inventors Bonny Banerjee, Daniyal Anjum, Omar Abbasi and David J. Kim, of (xiv) U.S. patent application Ser. No. 19/386,258 entitled UNIFIED SYSTEM FOR SELECTIVE ATTENTION IN MULTI-SOURCE ENVIRONMENTS and filed on Nov. 12, 2025 by inventors Bonny Banerjee, Daniyal Anjum, Omar Abbasi and David J. Kim, of (xv) U.S. patent application Ser. No. 19/387,549 entitled MULTI-STREAM SOURCE SEPARATION WITH CROSS-MODAL ENHANCEMENT and filed on Nov. 12, 2025 by inventors David J. Kim, Omar Abbasi, Daniyal Anjum and Bonny Banerjee, of (xvi) U.S. patent application Ser. No. 19/387,630 entitled MULTI-DEVICE AUDIO-BASED SPATIAL TRACKING and filed on Nov. 13, 2025 by inventors David J. Kim, Omar Abbasi, Daniyal Anjum and Bonny Banerjee, of (xvii) U.S. patent application Ser. No. 19/387,944 entitled GAZED-BASED ATTENTION and filed on Nov. 13, 2025 by inventors David J. Kim, Omar Abbasi, Daniyal Anjum and Bonny Banerjee, and of (xviii) PCT Application No. PCT/US25/29916 entitled SELECTIVE AUDITORY ATTENTION IN MULTI-PARTICIPANT ENVIRONMENTS and filed on May 18, 2025 by inventors David J. Kim, Omar Abbasi, Daniyal Anjum and Bonny Banerjee, the contents all of which are incorporated herein by reference in their entireties.

### FIELD OF THE INVENTION

The field of the invention is attention inference.

### BACKGROUND OF THE INVENTION

In complex auditory environments, the human auditory system naturally focuses attention on specific speakers of interest while filtering out background noise, commonly known as the “cocktail party effect.” This biological capability enables selective attention to individual conversations in noisy environments. Modern wearable devices and mixed reality systems aim to replicate and enhance this natural ability, presenting both significant opportunities and technical challenges in multi-speaker scenarios.

### SUMMARY

There is thus provided in accordance with an embodiment of the present invention a closed-loop selective attention system for resolving conflicts in multi-source or multi-speaker environments, including a plurality of internal attention models, each outputting a probability distribution over candidate sources and an associated confidence score, a fuser detecting conflicts when two or more of said attention models output high-confidence predictions that disagree, a selective sampling policy querying one or more external agents, wherein each external agent possesses a knowledge base, a reliability model, and a communication protocol, a trust and reliability module assigning and updating dynamic trust scores for internal and external agents based on past performance, an efficiency optimizer minimizing communication overhead and decision delay by balancing token usage cost and latency cost, and a dynamical system formulator ensuring convergence of the conflict resolution process under bounded trust, decaying step size, and limited sampling.

Additionally, the fuser incorporates both internal model outputs and an external evidence correction term, thereby refining the fused belief distribution using opportunistically acquired external knowledge.

Further, the external agents are heterogeneous and include at least one of: sensors, large language models, human interlocutors, external selective attention systems, or online information services.

Yet further, the selective sampling policy maps model outputs into a probability distribution over external agents to determine which external agent to query, and when to terminate the querying process.

Moreover, the trust and reliability module dynamically updates trust scores based on online or offline assessment of historical accuracy, consistency, and timeliness of responses from each agent.

Additionally, the efficiency optimizer computes efficiency as a joint function of token usage cost and latency cost, and schedules communications to minimize expected total cost.

Further, queries to external agents are formulated as natural language prompts constructed from a shared vocabulary subset, enabling uniform communication with both structured and unstructured knowledge sources.

Yet further, opportunistic communication pathways are established dynamically and only when conflicts occur, thereby reducing unnecessary bandwidth and energy consumption.

Moreover, the dynamical system formulator guarantees convergence of the conflict resolution process to a stable decision state, given bounded trust values, step size decay, and sampling constraints.

Additionally, the system further includes a multi-agent conversation graph that encodes listener-speaker relationships, attention switching events, and isolated sources, thereby enabling higher-level conversational reasoning.

Further, deferred high-utility suppressed signals are scheduled for presentation to the user using a decay-aware scheduling algorithm, ensuring maximal retention of utility despite presentation delays.

Yet further, attention decisions are context-aware, being adapted based on environmental conditions, source profiles, and historical conversation dynamics.

### BRIEF DESCRIPTION OF THE DRAWINGS

The present invention will be more fully understood and appreciated from the following detailed description, taken in conjunction with the drawings in which:

FIG. 1 is a simplified illustration of the setup of our selective attention (SA) agent and its environment, in accordance with an embodiment of the present invention; and

FIG. 2 is a simplified flow diagram showing the steps of a conflict resolution method that is executed in an agent whenever the agent encounters a conflict, in accordance with an embodiment of the present invention.

The following is a glossary of notation used in the description below.
M: Total number of agents (sources), including external ones.
K: Number of in-system agents (K<M).
N: Number of independent in-system models producing probability distributions.
Pᵢ: Probability distribution from model (i), Pᵢ=[pᵢ₁, pᵢ₂, . . . , pᵢₖ]
cᵢ: Confidence score from model (i).
θ_{conflict}: Confidence threshold above which conflicts are detected.
qₜ: Fused posterior belief distribution over K possible attention sources at time (t).
θ_{dec}: Decision threshold which represents the minimum confidence level required for an agent to finalize a decision on which source to attend to without needing further sampling or queries from external sources.
Lₘ(oₘ|k): Likelihood of observation oₘ from source m under hypothesis k.
rₘ: Reliability score of source m, learned from past performance.
θₘ: Prompt policy parameters for source m.
λₜ: Token cost per unit time (efficiency metric).
B: Average token-rate budget.
Îₘ: Expected information gain.
T̅: Expected token cost.
C^{lat}: Latency cost.
H(q): Entropy of q.
Uₘ(qₜ): Expected utility of querying source m, often related to entropy reduction.
πₜ(m): Probability of selecting source m at time t.
KB: Knowledge base associated with each agent.

### DETAILED DESCRIPTION

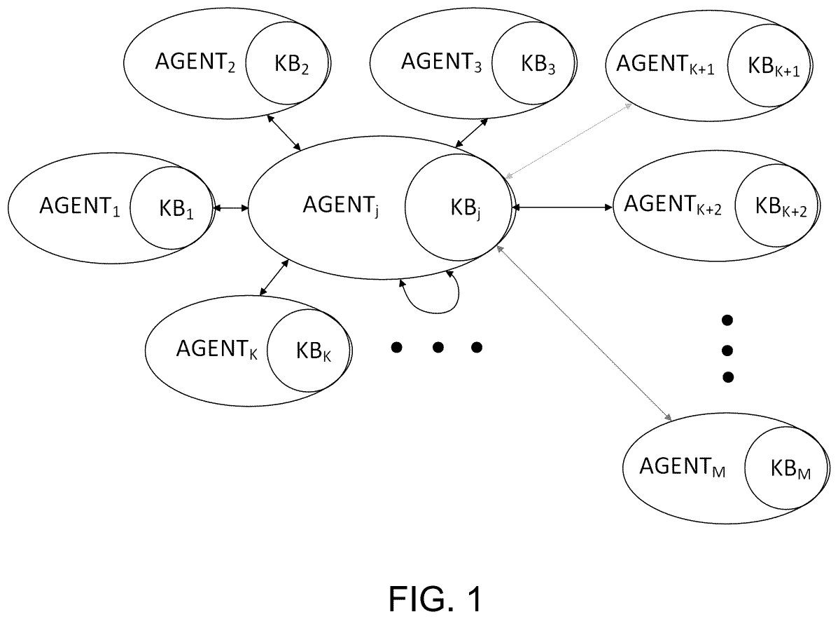

Reference is made to FIG. 1, which is a simplified illustration of the setup of an selective attention (SA) agent and its environment, in accordance with an embodiment of the present invention. There are M independent agents {Agent₁, Agent₂, . . . , Agent_{M}} that opportunistically communicate with each other in order to resolve conflicts. Each agent stores its knowledge in a knowledge base (KB). These M independent agents include K (K<M) independent agents {Agent₁, Agent₂, . . . , Agent_{K}} that always provide input to SA agent (Agentⱼ). Agentⱼ itself is one of the K agents because it always provides input to itself from its own knowledge base (KBⱼ). The other M−K agents {Agent_{K+1}, Agent_{K+2}, . . . , Agent_{M}} do not always provide input to SA agent. The agents and the arrows constitute an attention or communication graph, where the agents are nodes and the arrows are links that depict the probability of communication between a pair of agents at the current time. An arrow is bidirectional as it depicts back and forth communication between a pair of agents. The color intensity of an arrow depicts the probability of current communication between a pair of agents; darker the color, higher is the probability. As the agents and communication probabilities change over time, the above diagram shows a snapshot of the attention or communication graph in time.

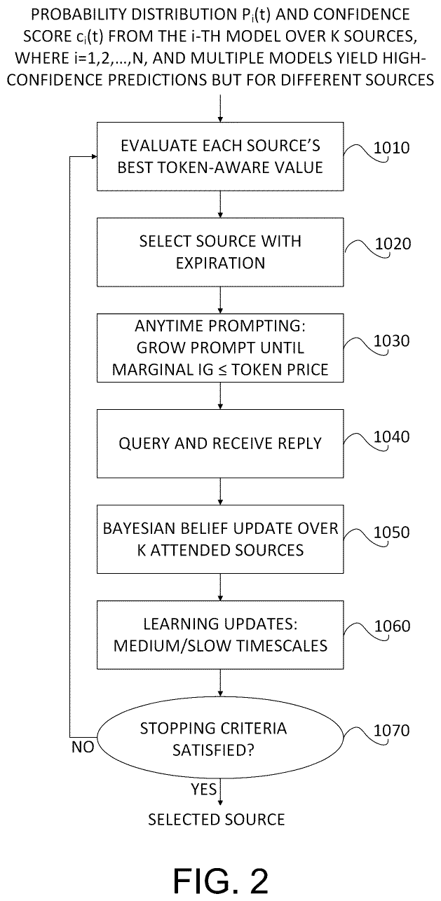

Reference is made to FIG. 2, which is a simplified flow diagram showing operations of a conflict resolution method that is executed in an agent whenever the agent encounters a conflict, in accordance with an embodiment of the present invention.

Embodiments of the present invention provide a unified system for selective attention (SA) in multisource environments, in which there are N independent models (or algorithms), each of which outputs a probability distribution over K independent sources (or agents): Pᵢ(t)=[pᵢ₁(t), . . . , p_{iK}(t)] and a confidence score

$${c}_{i} ( t ) = {max}_{j} {p}_{i j} ( t ) ∈ [ 0 , 1 ] ,$$

where i is the index of the agent and j is the index of the algorithm. If multiple models yield high-confidence predictions (cᵢ(t)>θ_{conflict}) that are not in agreement, how the SA system must resolve the conflict to decide which one of the K sources to attend to at any point of time.

Let there be M independent sources, where M>K. These M independent sources include the K independent sources that are part of the SA system and always provide input to the SA system. The other M−K sources are not part of the SA system and do not always provide input to the SA system. The SA system is modeled as an agent that samples these M sources as and when needed to resolve its conflict. These M sources include sources of data or signals (e.g., sensors like microphones, video-cameras and EEG sensors) and sources of knowledge (e.g., Internet search engines, chatbots/LLMs, SA systems of other users, the subject SA system's own knowledge base or memory, human beings). Each source possesses some unique data or knowledge. In general, their data or knowledge is noisy and incomplete, and the sources are partially reliable.

Whenever a conflict occurs, the fusion model in the subject SA system (modeled as an agent) selectively samples the source that has the highest certainty of providing the data or knowledge to resolve its conflict. This selective sampling requires learning two things: (i) Whom to sample? and (ii) How to sample? If the first sampled source fails to provide adequate data or knowledge to resolve the conflict, the SA agent might sample it again or sample the next best source. In order to achieve this, the SA agent learns a policy that maps the probability distribution over K independent sources: Pᵢ=[Pᵢ₁, . . . , p_{iK}] and a confidence score

$${c}_{i} = {max}_{j} {p}_{i j} ∈ [ 0 , 1 ]$$

to a probability distribution of the M sources which represents the sampling probabilities of the M sources. The SA agent also learns how to sample each source. Assuming each source can converse in natural language (say English) about its own data or knowledge, the SA agent has to formulate a sentence or prompt in natural language and send it to the agent it wants to sample. There is a vocabulary of terms in natural language; each source and the SA agent knows a subset of this vocabulary relevant to its data or knowledge.

The subject SA system is a closed-loop dynamical system for conflict resolution via selective sampling of M sources. It performs the following operations:
(i) maps the current conflict state into sampling probabilities over the M sources,
(ii) queries one or more sources with an information-seeking prompt,
(iii) updates belief about the target among the K attended sources, and
(iv) adapts reliabilities and prompt policies.

Under mild assumptions, the SA system converges to a stable fixed point.

In addition to accuracy, efficiency is a key concern in the operation of the SA agent. The efficiency of the SA agent is defined by the total number of tokens it has sent and received on average per unit time. Thus, the messages sent by each agent should be as few and as brief and informative as possible. When all of the M sources follow the same communication protocol (i.e., how to sample) as the SA agent, the conflict-resolution dynamical system token-is made efficient by turning it into a constrained information-seeking controller: maximize information gained about the attended source per unit communication while respecting a token-rate budget. A token cost model, a budget (or price) on tokens, and early-stopping or escalation rules are added to the SA agent.

### Setting

In-system estimators: For each time t, there have N models producing probability vectors over K attended sources (or agents),

$${P}_{i} ( t ) = [ {p}_{i 1} ( t ) , … , {p}_{iK} ( t ) ] , {c}_{i} ( t ) = max {p}_{i j} ( t ) ∈ [ 0 , 1 ] .$$

Fused belief over attended sources: qₜ∈Δ^{K-1} with qₜ(k)=Pr(true attended=k|state at t), where

$${q}_{t} = {\sum }_{i = 1}^{N} {w}_{i , t} {P}_{i} + Δ ,$$

Δ is the correction (or adjustment) term that captures external knowledge or information gained through selective sampling from the M−K external sources. Specifically, Δ accounts for any new evidence that is not contained in the N internal model outputs, but obtained by querying external sources (e.g., sensors, Internet, memory, other SA systems). It serves as a bias-correction or update factor, ensuring the fused belief qₜ integrates both the internal consensus (weighted sum of Pᵢ) and external knowledge. In practice, Δ may be derived as a Bayesian update or a small adjustment vector scaled by the reliability of the external source: Δ=η·Rₛ·\tilde{P}ₛ, where \tilde{P}ₛ is the probability distribution suggested by sampled external source s, Rₛ∈[0,1] is its reliability score, and η is a learning rate or influence factor controlling how strongly external evidence shifts the fused belief. So, Δ is an external evidence correction term.

Extended source universe: {1, . . . , M} contains the K in-system sources plus M−K external sources (sensors, LLMs, humans, KBs). Each source m has a reliability rₘ(t) and may be queried using a prompt policy parameterized by θₘ.

Efficiency metric: Average token rate (sent+received tokens per unit time) must be ≤B.

### Conflict Detection

A conflict episode is triggered when high-confidence estimators disagree and the fused belief is not yet decisive. A simple rule for conflict detection:

$$Conflict ( t ) ⇔ ( ∃ i \neq j \text{:} arg max {P}_{i} ( t ) \neq arg max {P}_{j} ( t ) ) and {max}_{k} {q}_{t} ( k ) < {θ}_{dec} .$$

where θ_{dec} is the decision threshold which represents the minimum confidence level (or certainty in the fused belief distribution qₜ) required for an agent to finalize a decision on which source to attend to without further sampling the sources. If

$${max}_{k} {q}_{t} ( k ) \geq {θ}_{dec} ,$$

the agent is confident enough to choose source

$${k}^{*} = {arg max}_{k} {q}_{t} ( k ) ;$$

else the agent engages in selective sampling (querying additional sources/agents) to reduce uncertainty. So, θ_{dec} controls the trade-off between accuracy and efficiency. A higher θ_{dec} makes the system more cautious (requiring stronger consensus before deciding, but potentially sending more queries).

Within a conflict episode, the agent may issue one or more queries to external sources to reduce uncertainty.

### Information Gain, Token Cost and Latency Cost

If the agent queries source m with a prompt a at time t, it receives a reply y drawn from a learned response model Lₘ(y|k,a). The expected information gain (IG) on the attended label k E {1, . . . , K} is

$${\hat{I}}_{m} ( t , a ) = {𝔼}_{y \sim {p}_{m ( \cdot \vert a , {q}_{t} )}} [ {D}_{KL} ( {q}_{t} \vert \vert {q}_{t + 1} ( y , a , m ) ) ] ,$$

where the posterior after observing y is

$${q}_{t + 1} ( k ) = \frac{{q}_{t} ( k ) {L}_{m} ( y \vert k , a )}{{\sum }_{j = 1}^{K} {q}_{t} ( j ) {L}_{m} ( y \vert j , a )} .$$

Each query incurs an expected token cost T̅(m,a)= [symbol] [Tokₜ(m,a)] (send+receive tokens), and a latency cost

$${C}_{m}^{lat} ( a ) .$$

A token-aware value for querying m with a is defined as follows.

$${V}_{m} ( t , a ) = {r}_{m} ( t ) {\hat{I}}_{m} ( t , a ) - {λ}_{t} \overline{T} ( m , a ) - μ {C}_{m}^{lat} ( a ) ,$$

where rₘ(t) is source reliability, λₜ≥0 is the token price that enforces a long-run token budget B, and μ≥0 prices latency.

Latency Cost (Definition): To capture the delay in conflict resolution and signal delivery, a latency cost is also included.

For each decision at time t, let
Tᵣₑₛ(t): the total time (in seconds) taken from the moment a conflict is detected until the conflict is resolved (decision finalized).
T_{ideal}: the minimal or baseline resolution time, e.g., if the system immediately made a confident decision without extra sampling.

The latency cost is computed as the relative delay beyond the ideal baseline resolution time:

$${C}_{lat} ( t ) = \frac{{T}_{res} ( t ) - {T}_{ideal}}{{T}_{ideal}}$$

Cₗₐₜ(t)=0: decision was made at the ideal speed (no extra delay).
Cₗₐₜ(t)>0: decision was delayed due to extra sampling or communication.

Integration with Efficiency: Since efficiency is measured as tokens per unit time, the total efficiency cost balances both tokens and latency:

$${C}_{eff} ( t ) = α \cdot \frac{{T}_{send} ( t ) + {T}_{recv} ( t )}{Δ} + β \cdot {C}_{lat} ( t )$$

where
T_{send}(t): tokens sent in interval Δt
T_{recv}(t): tokens received in interval Δt
α, β: weighting factors trading off token cost vs. latency cost.

Average Latency: Over an observation period T:

$${\overline{C}}_{lat} = \frac{1}{T} {\sum }_{c = 1}^{T} {C}_{lat} ( t )$$

This gives an average relative latency cost for the SA agent.

### Source Selection

At time t, the SA system chooses the source with the highest token-aware value, while maintaining exploration to ensure learnability:

$${π}_{t} ( m ) = \frac{exp ( β {max}_{a} {V}_{m} ( t , a ) )}{{\sum }_{j = 1}^{m} exp ( β {max}_{a} {V}_{j} ( t , a ) )} , {m}_{t} \sim {π}_{t} ( \cdot ) ,$$

with persistent exploration πₜ(m)>ϵₜ/M, e.g., Boltzmann with a small exploration floor.

### Prompt Design

For the chosen source mₜ, a prompt aₜ that maximizes Vₘ_{ₜ}(t,a) is selected:

$${a}_{t} ∈ arg {max}_{a ∈ {𝒜}_{{m}_{t}}} {V}_{{m}_{t}} ( t , a ) .$$

Anytime prompting for efficiency: The prompt is built token-by-token and stops when the marginal IG per token falls below the current token price:

$$Δ {\hat{I}}_{{m}_{t}} ( t , L ) \leq {λ}_{t} , stop at length {L}^{*} .$$

This is optimal when Îₘ_{ₜ}(t,L) exhibits diminishing returns (concavity/submodularity) in prompt length.

Shared protocol: All sources and the agent share a communication protocol and a possibly overlapping vocabulary; the agent learns templates and slot-filling strategies that maximize IG per token for each source type.

### Belief Update

Upon receiving reply yₜ from mₜ to aₜ, the SA agent updates its belief over the K attended sources via Bayes' rule:

$${q}_{t + 1} ( k ) = \frac{{q}_{t} ( k ) {L}_{{m}_{t}} ( {y}_{t} \vert k , {a}_{t} )}{{\sum }_{j = 1}^{K} {q}_{t} ( j ) {L}_{{m}_{t}} ( {y}_{t} \vert j , {a}_{t} )} .$$

The current attended source decision becomes

$${\hat{k}}_{t + 1} = arg {max}_{k} {q}_{t + 1} ( k ) .$$

The conflict episode ends when

$${max}_{k} {q}_{t + 1} ( k ) \geq {θ}_{dec}$$

or no informative/feasible queries remain.

### Reliability Adaptation

Entropy drop per token is used as the universal reward signal:

$${R}_{t} = \frac{H ( {q}_{t} ) - H ( {q}_{t + 1} )}{{Tok}_{t} ( {m}_{t} , {a}_{t} )} , H ( q ) = - {\sum }_{k} q ( k ) log q ( k ) .$$

where H(⋅) is entropy. Reliability of the queried source is updated via EMA clipped to [0,1]:

$${r}_{{m}_{t}} ( t + 1 ) = ( 1 - {α}_{r} ) {r}_{{m}_{t}} ( t ) + {α}_{r} σ ( {η}_{R} {R}_{t} ) ,$$

with logistic squashing σ and small stepsize αᵣ. Optionally, mild decay is applied to unqueried sources to track non-stationarity.

### Token Price Update

To meet the long-run token budget (B), the token price is adapted by dual ascent:

$${λ}_{t + 1} = {[ {λ}_{t} + {η}_{λ} ( {Tok}_{t} ( {m}_{t} , {a}_{t} ) - B ) ]}_{+} .$$

If usage exceeds the budget, λₜ increases, shortening prompts and reducing querying; if usage is below budget, λₜ decreases, allowing richer prompts when they buy information.

### Prompt-Policy Learning

Prompt parameters θₘ_{ₜ} are updated on the slowest timescale to maximize IG per token (minus latency penalty):

$${θ}_{{m}_{t}} ← {θ}_{{m}_{t}} + {η}_{θ} {∇}_{{θ}_{{m}_{t}}} ( H ( {q}_{t} ) - H ( {q}_{t + 1} ) / {Tok}_{t} ( {m}_{t} , {a}_{t} ) - μ {C}_{{m}_{t}}^{lat} ( {a}_{t} ) ) .$$

### Full Token-Aware Conflict Resolution Loop

```
while conflict(q_t):
  # 1) Evaluate each source's best token-aware value
  for m in 1..M:
    a*_m ← argmax_a r_m(t)*Ĩ_m(t,a) − λ_t*T⁻(m,a) − μ*C_lat
(m,a)
    V_m ← r_m(t)*Ĩ_m(t,a*_m) − λ_t*T⁻(m,a*_m) − μ*C_lat(m,a
*_m)
  # 2) Select source with exploration
  sample m_t ~ softmax_β(V_1..V_M), with floor ε_t/M
  # 3) Anytime prompting (grow until marginal IG ≤ token price
)
  a_t ← GrowPromptTokenByToken(m_t)
  # 4) Query and receive reply
  y_t, Tok_t ← Query(m_t, a_t)
  # 5) Bayesian belief update over K attended sources
  q_{t+1} ← BayesUpdate(q_t, y_t, m_t, a_t)
  # 6) Learning updates (medium/slow timescales)
  R_t ← (H(q_t) − H(q_{t+1})) / Tok_t
  r_{m_t} ← (1−α_r)*r_{m_t} + α_r*σ(η_R * R_t)
  λ_{t+1} ← max{0, λ_t + η_λ*(Tok_t − B)}
  θ_{m_t} ← θ_{m_t} + η_θ * ∇_{θ_{m_t}}( (H(q_t)−H(q_{t+1}})/T
ok_t − μ*C_lat(m_t,a_t) )
  # 7) Stopping rule
  if max_k q_{t+1}(k) ≥ θ_dec: break
```

### Convergence Analysis

The process is analyzed as three-timescale stochastic approximation with step sizes obeying Robbins-Monro conditions—for each block, sums diverge, squared sums converge:

$$( fast ) {q}_{t} ≫ ( medium ) ( {r}_{t} , {λ}_{t} ) ≫ ( slow ) {θ}_{t} .$$

### Assumptions

A1 (Informativeness/Identifiability): There exists at least one source-prompt pair (m,a) such that the expected KL reduction about the true class is strictly positive in a neighborhood of the truth: [symbol] [Îₘ(t,a)]>ϵ>0.
A2 (Diminishing returns): Îₘ(t,L) is concave/submodular in prompt length L (justifying the marginal IG stopping rule).
A3 (Boundedness & Lipschitzness): Likelihoods, surrogates, and gradient estimates are bounded with bounded variance and are Lipschitz in parameters.
A4 (Persistent exploration): Each informative source is sampled infinitely often almost surely

$$( e . g . , {\sum }_{t} {ϵ}_{t} = ∞ , {\sum }_{t} {ϵ}_{t}^{2} < ∞ ) .$$

A5 (Feasible token budget): There exists a policy achieving average token usage strictly below B (Slater condition).
   Results (sketch)
Posterior consistency: On the fast timescale, the Bayesian update with informative queries drives qₜ->δ_{k*} (concentration on the true attended source).
Budget satisfaction: Dual ascent on λₜ enforces the long-run average token rate B; at stationarity, the average marginal IG per token equals the token price λ*.
Reliability convergence: rₘ(t) converges to fixed points proportional to long-run IG per token delivered by each source, naturally prioritizing efficient sources.
Prompt-policy stationarity: θₘ converges to stationary points of the expected IG-per-token objective on the slowest timescale.

Taken together, via the ODE method and Borkar-Meyn stability, the joint process converges to a stable equilibrium where the agent makes correct attention decisions while operating at an efficient token rate.

### Design Guidelines

Universal reward: Use entropy drop per token for both reliability learning and prompt optimization.
Anytime prompting: Start with a terse “ping”; extend only while marginal IG exceeds the token price.
Coarse-to-fine querying: Prefer cheap, high-yield sources first; escalate to costlier sources only if needed.
Latency coupling: Include C^{lat} when delayed information loses value; otherwise rely on IG only.
Template prompts & shared vocabulary: Standardize slot-based prompts tuned per source class to maximize IG per token.
Parallelism: When several cheap sources are available, issue parallel short queries and multiply likelihoods in the Bayes update.
Preemption: If a newly available query promises higher Vₘ, preempt current escalation and reschedule.

### Extensions

Context-aware decision threshold: Let θ_{dec} adapt to context and reliability (higher when sources disagree, lower when agreement is strong).
Risk-sensitive value: Replace IG with risk-adjusted utility that prioritizes safety-critical errors.
Batch lookahead: Short finite-horizon planning over a few prospective queries (myopic IG often suffices, but lookahead helps with path-dependent sources).
Nonstationary tracking: Add slow decay to rₘ and periodic re-calibration of Lₘ to track drift.

### SUMMARY OF KEY EQUATIONS

$$Token - aware value \text{:} {V}_{m} ( t , a ) = {r}_{m} {\hat{I}}_{m} ( t , a ) - {λ}_{t} \overline{T} ( m , a ) - μ {C}_{m}^{lat} ( a ) .$$

$$Source policy \text{:} {π}_{t} ( m ) ∝ exp ( β {max}_{a} {V}_{m} ( t , a ) ) with exploration floor .$$

$$Anytime stopping \text{:} Stop prompt growth when Δ {\hat{I}}_{m} ( t , L ) \leq {λ}_{t} .$$

$$Bayes updates \text{:} {q}_{t + 1} ( k ) = \frac{{q}_{t} ( k ) {L}_{{m}_{t}} ( {y}_{t} \vert k , {a}_{t} )}{{\sum }_{j = 1}^{K} {q}_{t} ( j ) {L}_{{m}_{t}} ( {y}_{t} \vert j , {a}_{t} )} .$$

$$Reliability update \text{:} {r}_{{m}_{t}} ← ( 1 - {α}_{r} ) {r}_{{m}_{t}} + {α}_{r} σ ( {η}_{R} \frac{H ( {q}_{f} ) - H ( {q}_{t + 1} )}{{Tok}_{t}} ) .$$

$$Token price update \text{:} {λ}_{t + 1} = {[ {λ}_{t} + {η}_{λ} ( {Tok}_{t} - B ) ]}_{+} .$$

$$Prompt policy update \text{:} {θ}_{{m}_{t}} ← {θ}_{{m}_{t}} + {η}_{θ} {∇}_{{θ}_{{m}_{t}}} ( H ( {q}_{t} ) - H ( {q}_{t + 1} ) / {Tok}_{t} - μ {C}^{lat} ) .$$

What is claimed is:

1. A closed-loop selective attention system for resolving conflicts in multi-source or multi-speaker environments, comprising:
a plurality of internal attention models, each outputting a probability distribution over candidate sources and an associated confidence score;
a fuser detecting conflicts when two or more of said attention models output high-confidence predictions that disagree;
a selective sampling policy querying one or more external agents, wherein each external agent possesses a knowledge base, a reliability model, and a communication protocol;
a trust and reliability module assigning and updating dynamic trust scores for internal and external agents based on past performance;
an efficiency optimizer minimizing communication overhead and decision delay by balancing token usage cost and latency cost; and
a dynamical system formulator ensuring convergence of the conflict resolution process under bounded trust, decaying step size, and limited sampling.

2. The system of claim 1, wherein said fuser incorporates both internal model outputs and an external evidence correction term, thereby refining the fused belief distribution using opportunistically acquired external knowledge.

3. The system of claim 1, wherein the external agents are heterogeneous and include at least one of: sensors, large language models, human interlocutors, external selective attention systems, or online information services.

4. The system of claim 1, wherein said selective sampling policy maps model outputs into a probability distribution over external agents to determine which external agent to query, and when to terminate the querying process.

5. The system of claim 1, wherein said trust and reliability module dynamically updates trust scores based on online or offline assessment of historical accuracy, consistency, and timeliness of responses from each agent.

6. The system of claim 1, wherein said efficiency optimizer computes efficiency as a joint function of token usage cost and latency cost, and schedules communications to minimize expected total cost.

7. The system of claim 1, wherein queries to external agents are formulated as natural language prompts constructed from a shared vocabulary subset, enabling uniform communication with both structured and unstructured knowledge sources.

8. The system of claim 1, wherein opportunistic communication pathways are established dynamically and only when conflicts occur, thereby reducing unnecessary bandwidth and energy consumption.

9. The system of claim 1, wherein said dynamical system formulator guarantees convergence of the conflict resolution process to a stable decision state, given bounded trust values, step size decay, and sampling constraints.

10. The system of claim 1, further comprising a multi-agent conversation graph that encodes listener-speaker relationships, attention switching events, and isolated sources, thereby enabling higher-level conversational reasoning.

11. The system of claim 1, wherein deferred high-utility suppressed signals are scheduled for presentation to the user using a decay-aware scheduling algorithm, ensuring maximal retention of utility despite presentation delays.

12. The system of claim 1, wherein attention decisions are context-aware, being adapted based on environmental conditions, source profiles, and historical conversation dynamics.
